(19) United States
(12) Patent Application Publication
(10) Pub. No.: US 2019/0186281 A1
(43) Pub. Date: Jun. 20, 2019

(54) COMPRESSOR ABRADABLE SEAL WITH IMPROVED SOLID LUBRICANT RETENTION

(71) Applicant: United Technologies Corporation, Farmington, CT (US)

(72) Inventors: Pantcho Stoyanov, West Hartford, CT (US); Christopher W. Strock, Kennebunk, ME (US); Kevin Seymour, Hartford, CT (US)

(73) Assignee: United Technologies Corporation, Farmington, CT (US)

(21) Appl. No.: 15/848,729

(22) Filed: Dec. 20, 2017

(51) Int. Cl. F01D 11/12; F01D 25/00

(52) U.S. Cl. CPC F01D 11/122; F01D 25/005; F05D 2220/32; F05D 2240/55; F05D 2230/312; F05D 2230/40; F05D 2300/603; F05D 2300/177; F05D 2300/48; F05D 2300/173; F05D 2230/237; F05D 2230/42; F05D 2230/60

(57) ABSTRACT

An air seal in a gas turbine engine includes a substrate. A bond coating layer is adhered to the substrate. An abradable layer is adhered to the bond coating layer. The abradable layer comprises a metal matrix discontinuously filled with a lubricious oxide solid lubricant filler.

### BACKGROUND

The disclosure relates to an abradable coating for a gas turbine engine.

In compressor and turbine sections of a gas turbine engine, air seals are used to seal the interface between rotating structure, such as a hub or a blade, and fixed structure, such as a housing or a stator. For example, typically, circumferentially arranged blade seal segments are fastened to a housing, for example, to provide the seal.

Relatively rotating components of a gas turbine engine are not perfectly cylindrical or coaxial with one another during engine operation. As a result, the relatively rotating components may occasionally rub against one another. To this end, an abradable material typically is adhered to the blade seal segments or full rings and/or the rotating component.

Abradable seals in the compressor section of gas turbine engines include characteristics such as, good abradability, spall resistance, and erosion resistance. Abradable seals are required to exhibit a smooth surface, low gas permeability, and environmental durability. The seal is a sacrificial element in order to minimize blade wear, so it is abradable. The seal must also minimize gas flow leakage through the seal, so a low gas permeability is desirable.

Abradable coatings for the seals are always a compromise between abradability and erosion resistance. In order to maintain blade tip clearances over time, the seal material needs to be tough and resistant to erosion. Conventional seal materials tend to be soft and weak in order to have good abradability. However, current understanding of the wear mechanisms involved with high pressure compressor (HPC) abradable materials, while rubbed with bare Nickel (Ni) alloy blades, is that wear takes place by adhesive wear mechanisms, plastic deformation and fracture on a scale far smaller than the size of coating constituent particles. This becomes apparent when one considers that the wear per blade passage is on the order of 1 E −6 inches.

Coating systems can consist of a nickel or cobalt based abradable with hexagonal boron nitride (hBN) as the solid lubricant phase. High blade wear events are being attributed to several factors including loss of the solid lubricant phase at the coating surface which leads to increased frictional heating during rub, plastic deformation at the blade to abradable interface and formation of a densified surface layer. The result is high frictional heating and excessive blade wear. In addition to an undesirable wear ratio and the resultant more open tip clearances, the high contact temperatures of the degraded systems may cause metallurgical changes to the blade tips that result in cracking.

In addition to improving the wear performance of the HPC abradable seal system itself, there is a desire to improve the manufacturability and cost of the abradable. The current abradable uses costly hBN solid lubricant that does not melt during spray and deposits with a very low efficiency. This results in both high material cost and a time consuming manufacturing process.

There is a distinct need to develop a compressor abradable coating that minimizes loss of solid lubricant phase at the coating surface in order to better resist densification and the associated open tip clearances, blade wear and blade damage.

### SUMMARY

In accordance with the present disclosure, there is provided a seal comprising an abradable layer, the abradable layer comprises a metal matrix discontinuously filled with a lubricious oxide solid lubricant filler.

In another alternative embodiment a substrate is coupled to the abradable layer.

In another alternative embodiment the substrate is metallic.

In another alternative embodiment a bond coating layer is adhered to the substrate and the abradable layer is adhered to the bond coating.

In another alternative embodiment the abradable layer includes a metal fraction of from about 20 volume % to about 50 volume % metal and from about 5 volume % to about 50 volume % lubricious oxide solid lubricant filler.

In accordance with the present disclosure, there is provided a gas turbine engine comprising a first structure; a second structure rotatable relative to the first structure, wherein one of the first structure and second structure comprises a substrate; and an abradable layer adhered to the substrate, the abradable layer comprising a metal matrix discontinuously filled with a lubricious oxide solid lubricant filler.

In another alternative embodiment the substrate is an outer case, and the other rotating structure is a blade tip, wherein the blade tip is arranged adjacent the outer case without any intervening, separable seal structure.

In another alternative embodiment a bond coating layer is adhered to the substrate and the abradable layer is adhered to the bond coating layer.

In accordance with the present disclosure, there is provided a method of manufacturing a gas turbine engine air seal comprising depositing an abradable coating onto a substrate, the abradable coating comprising a metal matrix discontinuously filled with a lubricious oxide solid lubricant filler.

In another alternative embodiment the method of manufacturing a gas turbine engine air seal further comprises plasma spraying the abradable coating onto the substrate.

In another alternative embodiment the step of depositing the abradable coating onto a substrate includes at least one of hot pressing the abradable coating directly onto the substrate, as a pressed and sintered biscuit that is brazed on, glued, mechanically attached, attached by hot isostatic pressing, and sprayed directly onto the substrate.

In another alternative embodiment the abradable coating further comprises at least one of additional metal matrix particles, fugitive pore formers, and additional soft phase material in a composite powder.

In another alternative embodiment the method of manufacturing a gas turbine engine air seal further comprises adjusting the abradable coating properties during manufacture to target the properties required for a predetermined gas turbine engine section environment.

In another alternative embodiment the step of adjusting further comprises adjusting a ratio of the lubricious oxide particles to at least one of the additional metal matrix particles, and the fugitive pore formers, in a composite powder.

In another alternative embodiment the fugitive pore formers comprise at least one of a polyester particle and a Lucite particle.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a perspective view of a portion of a gas turbine engine incorporating an air seal.

FIG. 2 shows a schematic view of an air seal.

FIG. 3 shows a cross sectional view of a coating powder before being applied.

FIG. 4 shows a cross sectional view of a coating on a substrate.

FIG. 5 shows a cross sectional view of an exemplary abradable seal with lubricious oxide filler interfacing with a moving component.

Like reference numbers and designations in the various drawings indicate like elements.

### DETAILED DESCRIPTION

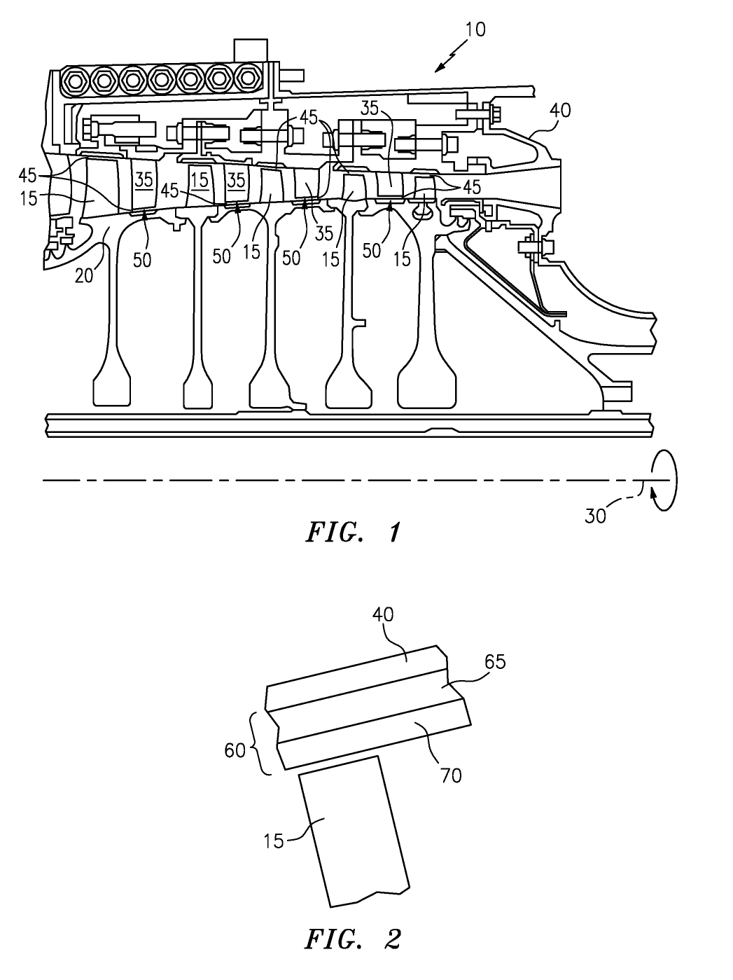

FIG. 1 shows a portion of a gas turbine engine 10, for example, a high pressure compressor section. The engine 10 has blades 15 that are attached to a hub 20 that rotate about an axis 30. Stationary vanes 35 extend from an outer case or housing 40, which may be constructed from a nickel alloy, and are axially interspersed between stages of the turbine blades 15, which may be constructed from titanium in one example. A first gap 45 exists between the blades 15 and the outer case 40, and a second gap 50 exists between the vanes 35 and the hub 20.

Air seals 60 (FIG. 2) are positioned in at least one of the first and second gaps 45, 50. Further, the air seals 60 may be positioned on: (a) the outer edge of the blades 15; (b) the inner edge of the vanes 35; (c) an outer surface of the hub 20 opposite the vanes 35; and/or (d) as shown in FIG. 2, on the inner surface of outer case 40 opposite the blades 15. It is desirable that the gaps 45, 50 be minimized and interaction between the blades 15, vanes 35 and seals 60 occur to minimize air flow around blade tips or vane tips.

In one example shown in FIG. 2, the air seal 60 is integral with and supported by a substrate, in the example, the outer case 40. That is, the air seal 60 is deposited directly onto the outer case 40 without any intervening, separately supported seal structure, such as a typical blade outer air seal. The tip of the blade 15 is arranged in close proximity to the air seal 60. It should be recognized that the seal provided herein may be used in any of a compressor, a fan or a turbine section and that the seal may be provided on rotating or non-rotating structure. The seal can also be for a turbine pump in a gas pipeline, a water or oil seal in a pump or other application.

The air seal 60 includes a bond coat 65 deposited onto the outer case 40. In an exemplary embodiment, the bond coat 65 may be a thermally sprayed bond coat. In another example, the bond coat 65 may comprise an alloy, such as PWA1365 MCrAlY composition applied by air plasma spray. In another exemplary embodiment, the bond coat 65 can be optional, if it is used, the bond coat 65 can be thermally sprayed, a braze material or a polymer adhesive. A composite topcoat 70 acts as an abradable layer that is deposited on the bond coat 65 opposite the outer case 40. In an exemplary embodiment, the metallic bond coat 65 may be replaced by an adhesive layer. The adhesive may be polyurethane or epoxy or silicone in the front stages of the compressor or in the fan where ambient temperature is sufficiently low (e.g., less than about 300 degrees Fahrenheit).

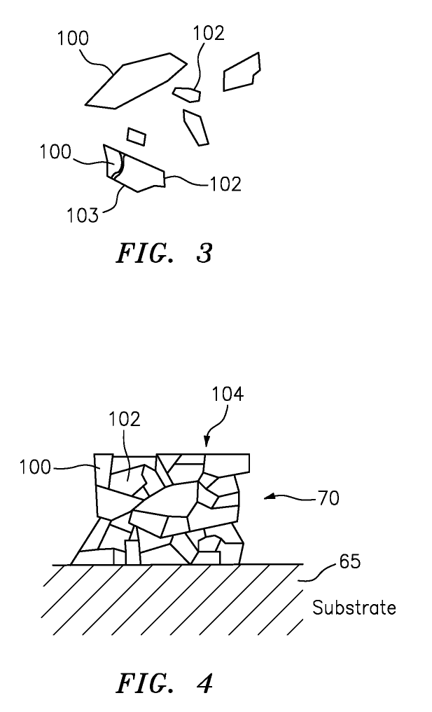

Referring also to FIGS. 3 and 4, the composite abradable coating 70 consists of a material that is a distribution of a Ni-based alloy 100 with a solid lubricant 102. Feed stock used to provide the air seal 60 abradable coating 70 is made of composite powder particles of Ni alloy 100 and a solid lubricant 102 which are used at a variable ratio with additional metal particles, and fugitive pore formers to adjust and target the coating properties during manufacture. In an exemplary embodiment, the fugitive pore formers can include polyester, methyl methacrylate (Lucite), and other organic materials that may be pyrolized or soluble materials such as salts that may be dissolved and leached out. In an exemplary embodiment, the additional metal particles may be the same composition as in the composite particles or different. The additional particles can be alloying elements such as Al, Cr, Si, and B which may serve as a processing aid or modify the matrix alloy to provide some desired property such as oxidation resistance. It may be desirable to add Cr and/or Al and the like, as separate particles. The composition of these particles may advantageously combine with the matrix metal to improve oxidation resistance or other property (by diffusion during heat treatment or in service).

In an exemplary embodiment, the abradable coating layer 70 includes a metal fraction of from about 20 volume % to about 50 volume % (v %) metal. The metal fraction can depend on the blade tips being bare metal or coated with an abrasive coating, as well as on the porosity of the coating. In an application with a hard coating that requires an abrasive tip, there may be <25 v % porosity. The lubricious oxide 102 will contribute to coating strength. This embodiment can have from about 5 volume % to about 50 volume % (v %) lubricious oxide lubricant. In exemplary embodiment with a softer coating layer 70 for rub against bare blade tips the porosity can be from about 40 volume % to about 75 volume % (v %) porosity. That porosity is a combination of “inherent porosity” created from the spray process and porosity left by removing a fugitive like polyester or Lucite (removal optional).

The lubricious oxide 102 can comprise a solid lubricant that has material properties enabling the solid lubricant to both melt during spray application for improved deposition characteristics and to be more durable to the environment at the free coating surface where softer lubricious particles such as hexagonal boron nitride tend to get removed by the action of the high velocity air and contaminant particles in the airflow. In an exemplary embodiment the lubricious oxide 102 can comprise a cobalt oxide solid lubricant, as well as other oxides, such as SnO₂, ZnO. In an exemplary embodiment the lubricious oxide for low temperature abradable coatings can comprise MoO₃ or ReO₂.

The matrix 100 of Ni based alloy may be agglomerated with the lubricious oxide 100 before thermal spraying. The matrix 100 and lubricious oxide 102 can be co-sprayed as separate particles or sprayed using the agglomerated particles 103. In an exemplary embodiment, the in-situ formation of the lubricious oxide 102 during spraying by use of different powder sizes. In an exemplary embodiment, the lubricious oxide 102 can comprise smaller particles and coarser particles of matrix 100 metallic materials. In an exemplary embodiment the lubricious oxide may be included as single or blended powdered oxide feed stock, as a component of an agglomerate or as fine metallic particles that oxidize during the spray process. In order to get conversion of a metallic precursor, the particles would need to be relatively fine compared with the powder that forms the metal matrix. That size may be on the order of 6-16 microns. In an exemplary embodiment, the particle sizes can vary from 44 microns to a maximum of 55 microns. In an exemplary embodiment, a composite of the metal particles can comprise 9% Cr, 1% Mo, 10% W, 3% Ta, 7% wt Al., 0.1% wt. Hf.

In an exemplary embodiment, the abradable coating properties can be adjusted during manufacture to target the properties required for a predetermined gas turbine engine section environment. The ratio of the lubricious oxide particles to at least one of the additional metal matrix particles, and the fugitive pore formers can be adjusted in the composite powder. In another exemplary embodiment, this can also be done by adjusting blend ratios or feed rates when supplying constituents via two or more feeders.

The volume fraction of lubricious oxide 102 in the composite coating 104 is about 50-80% with between 20-30% metal when there is low porosity former (0-15%). In another exemplary embodiment for a high porosity coating 104, there can be about 0-50% porosity former, 20-30% metal and 5-50% lubricious oxide. The target metal content of the coating may be around 50% by volume or less. In one example, a volume fraction of lubricious oxide in the range of 10-20% is used. The target metal fraction can be on the order of 75-80% by volume. Some porosity, 0.5 to 15 volume % is normal in thermal spray coatings depending on the process and material. A low volume fraction of fugitive may be desirable to further reduce density and rub forces without substantially affecting roughness and gas permeability (e.g., less than about 25 volume %).

An additional volume fraction may be porosity which is inherent to the thermal spray process or intentionally induced with spray parameter selection or the addition of a fugitive material. Example fugitive materials are polyester and Lucite powders. The low volume fraction of metal in combination with the lubricious oxide improves the ductility of a surface layer that forms by mechanical alloying due to plastic deformation as it is rubbed by an airfoil tip (or other rotating element) which results in good abradability. Low volume fraction of metal and poor bonding with the lubricious oxide also produces a low modulus composite that is somewhat flexible and compliant to part deformation and thermal expansion contributions to stress. The low modulus keeps stresses low.

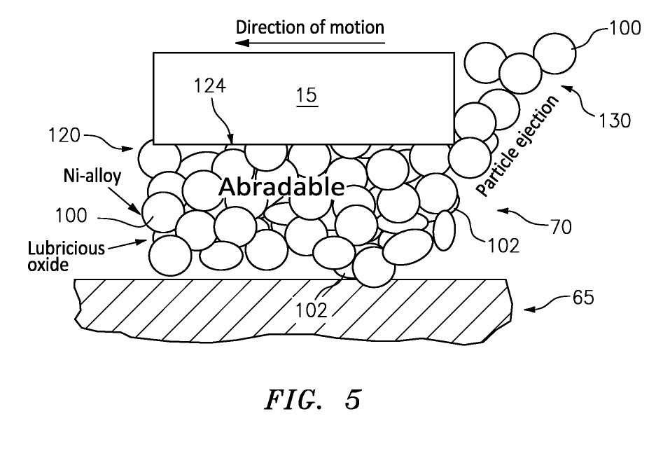

It should be noted that the ductile matrix phase provides toughness, erosion resistance, spallation and cracking resistance while the selection of matrix and filler combine to provide specific properties of the mechanically alloyed surface layer in order to promote abradability. The lubricious oxide is particularly well suited to forming a high ductility surface layer 124 because lubricous oxide does not bond well to the metal and when mixed into the metal weakens the surface layer 124 (FIG. 5), lowers the ductility and promotes the removal of wear particles from the surface.

The metal and lubricious oxide composite coating 104 bonds with the bond coat 65 through mechanical interlocking with the rough surface of the thermally sprayed bond coat 65, which provides a durable, low stress abradable layer that will remain bonded to the bond coat 65 during engine service including rub events.

The topcoat abradable layer 70 can be deposited through a variety of methods. In another alternative embodiment, the matrix 100 and lubricious oxide 102 can be pressed and sintered to form the composite coating 104. In an exemplary embodiment, the abradable layer 70 could be hot pressed directly onto the outer case substrate 40, as a biscuit that is brazed on, glued or mechanically attached, attached by hot isostatic pressing, pressed and sintered, as well as sprayed directly onto the outer case substrate 40 or bond coat 65. The powders are deposited by a known thermal spray process, such as high velocity oxygen fuel spraying (HVOF), and air plasma spray (APS) or cold spray.

As shown in FIG. 5, the exemplary abradable coating 70 can exhibit improved rub characteristics due to the improved ability to retain the solid lubricant particles 102 at the free surface 120 of the abradable coating 70. More specifically, the retention of solid lubricant 102 helps reduce frictional heating, surface deformation and densification. Further, it is in a very thin surface layer 124 where the continued presence of the solid lubricant 102 phase helps to separate matrix particles 100 and promote more efficient ejection of wear debris 130.

One or more embodiments have been described. Nevertheless, it will be understood that various modifications may be made. For example, the present disclosure seeks to provide a strong continuous network of metal matrix that is discontinuously filled with lubricious oxide material. This is accomplished in an efficient manner by mixing metal matrix and lubricious oxide or lubricious oxide and metal matrix agglomerates and depositing them by plasma spray methods.

The matrix abradable with lubricious oxide filler will improve the economics of manufacture, engine efficiency and reduce unscheduled engine removals (UER's) by improving tribological behavior of the abradable surface. The lubricious oxide will melt during deposition and incorporate into the coating much more efficiently than the current hBN lubricant phase which does not have a melting point. Once in the coating, the high thermal and mechanical stability of cobalt oxide compared with hBN, for example, will help it stay in the coating structure when exposed to the gas path.

Savings will be realized by reducing the manufacturing cost; improving thrust specific fuel consumption (TSFC) from the tighter tip clearances associated with reduced blade wear and elimination of blade material transfer to the abradable; allowing longer service intervals or multiple intervals for abrasive tips; and by preventing blade tip thermal damage which may scrap blades and IBRs.

During rub contact with blades, the surface temperatures will remain lower resulting in less blade wear and thermal damage. The present coating structure and composition results in improved toughness, erosion resistance for a given metal content while maintaining abradability. The composition and structure provides low roughness and low gas permeability due to near fully dense coating structure. Roughness can be reduced due to the well distributed phases and low porosity compared with conventional coating composite structures. Accordingly, other embodiments are within the scope of the following claims.

What is claimed is:

1. A seal comprising:
an abradable layer, the abradable layer comprising a metal matrix discontinuously filled with a lubricious oxide solid lubricant filler.

2. The seal of claim 1, further comprising:
a substrate coupled to said abradable layer.

3. The seal of claim 1, wherein the substrate is metallic.

4. The seal of claim 1, further comprising:
a bond coating layer adhered to the substrate;
said abradable layer adhered to said bond coating.

5. The seal of claim 1, wherein said abradable layer includes a metal fraction of from about 20 volume % to about 50 volume % metal and from about 5 volume % to about 50 volume % lubricious oxide solid lubricant filler.

6. A gas turbine engine comprising:
a first structure;
a second structure rotatable relative to the first structure, wherein one of the first structure and second structure comprises a substrate; and
an abradable layer adhered to the substrate, the abradable layer comprising a metal matrix discontinuously filled with a lubricious oxide solid lubricant filler.

7. The gas turbine engine of claim 6, wherein the substrate is an outer case, and the other rotating structure is a blade tip, wherein the blade tip is arranged adjacent the outer case without any intervening, separable seal structure.

8. The gas turbine engine of claim 6, further comprising:
a bond coating layer adhered to the substrate; and
said abradable layer adhered to said bond coating layer.

9. A method of manufacturing a gas turbine engine air seal comprising:
depositing an abradable coating onto a substrate, the abradable coating comprising a metal matrix discontinuously filled with a lubricious oxide solid lubricant filler.

10. The method of manufacturing a gas turbine engine air seal of claim 9 further comprising:
plasma spraying the abradable coating onto the substrate.

11. The method of manufacturing a gas turbine engine air seal of claim 9 wherein said depositing said abradable coating onto a substrate includes at least one of hot pressing said abradable coating directly onto the substrate, as a pressed and sintered biscuit that is brazed on, glued, mechanically attached, attached by hot isostatic pressing, and sprayed directly onto the substrate.

12. The method of manufacturing a gas turbine engine air seal of claim 9, wherein said abradable coating further comprises at least one of additional metal matrix particles, fugitive pore formers, and additional soft phase material in a composite powder.

13. The method of manufacturing a gas turbine engine air seal of claim 12 further comprising:
adjusting said abradable coating properties during manufacture to target the properties required for a predetermined gas turbine engine section environment.

14. The method of manufacturing a gas turbine engine air seal of claim 13 wherein said adjusting said abradable coating properties step further comprises adjusting a ratio of said lubricious oxide particles to at least one of said additional metal matrix particles, and said fugitive pore formers, in a composite powder.

15. The method of manufacturing a gas turbine engine air seal of claim 14 wherein said fugitive pore formers comprise at least one of a polyester particle and a Lucite particle.
